(19) United States
(12) Patent Application Publication
(10) Pub. No.: US 2019/0234766 A1
(43) Pub. Date: Aug. 1, 2019

(54) MAGNETIC SENSOR WITH BIFILAR WINDINGS

(71) Applicant: PRATT & WHITNEY CANADA CORP., Longueuil (CA)

(72) Inventors: Todd MILLER, Toronto (CA); Mehmet TANJU, Mississauga (CA)

(21) Appl. No.: 15/880,771

(22) Filed: Jan. 26, 2018

(51) Int. Cl. G01D 5/20; B64C 11/30; B64D 45/00

(52) U.S. Cl. CPC G01D 5/2013; B64D 45/0005; B64C 11/301

(57) ABSTRACT

Herein provided are sensing systems, methods, sensors, and methods of manufacturing a sensor for a rotating element in an engine. A magnetic core having first and second ends is positioned with the first end proximate the rotating element. A permanent magnet is positioned proximate the second end of the magnetic core and is configured for subjecting the magnetic core and the rotating element to a magnetic field. A bifilar winding comprising a first wire and a second wire electrically insulated from one another is wrapped around at least a portion of the magnetic core, the bifilar winding configured to generate a first signal in the first wire and a second signal in the second wire in response to rotation of the rotating element relative to the sensor.

### TECHNICAL FIELD

The present disclosure relates generally to magnetic sensors, and more specifically to magnetic sensors for use in aircraft.

### BACKGROUND OF THE ART

Various rotational sensors are commonly used in aircraft to measure a variety of operational parameters, including rotational velocity, torque, angular displacement, and the like. One approach for implementing a rotational sensor involves measuring induced voltages caused by changing magnetic fields or flux. For example, a ferromagnetic rotating part of the aircraft is subjected to a magnetic field, and the effect of the rotation on the induced field is measured.

Existing techniques for measuring changes in the magnetic field make use of a magnetic core, around which wire windings are wound. The magnetic core reflects the changes in the magnetic field, and causes an electrical voltage to be induced in the windings. Since aircraft regulations require redundancy for many sensors, the magnetic core is typically provided with multiple windings, wrapped in concentric fashion with a first winding wound around the core and subsequent windings wound in a superposed fashion over the first winding. This approach, however, can lead to the various windings having uneven coupling with the magnetic field which leads to different output voltage or signal amplitudes. Depending on the level of resolution required, this causes an error between independent, redundant signals and is prone to process variation during manufacturing.

Thus, improvements may be needed.

### SUMMARY

In accordance with a broad aspect, there is provided a sensing system for a rotating element in an engine. The sensing system comprises: a magnetic core having a first end and a second end, the magnetic core positioned with the first end proximate to the rotating element; a permanent magnet positioned proximate the second end of the magnetic core and configured for subjecting the magnetic core and the rotating element to a magnetic field; a bifilar winding comprising a first wire and a second wire electrically insulated from one another and wrapped around at least a portion of the magnetic core, the bifilar winding configured to generate a first signal in the first wire and a second signal in the second wire in response to rotation of the rotating element relative to the sensing system; and a control unit configured for using at least the first signal and the second signal to determine an angular displacement of the rotating element.

In some embodiments, the bifilar winding is wrapped around a portion of the magnetic core.

In some embodiments, the bifilar winding is wrapped around substantially the entire magnetic core.

In some embodiments, the magnetic core is cylindrical.

In some embodiments, the magnetic core is a rectangular prism.

In some embodiments, the rotating element is a gear.

In some embodiments, the control unit is configured for determining an angular velocity of the rotating element based on the angular displacement.

In some embodiments, the control unit is configured for determining a torque to which the rotating element is subjected based on the angular displacement.

In some embodiments, the control unit uses the first signal and the second signal to determine a mark/space ratio of a slanted-tooth gear, wherein the control unit is further configured for determining an axial position of the slanted-tooth gear based on the mark/space ratio.

In some embodiments, the control unit is further configured for determining a propeller blade angle based on the axial position of the rotating element.

In accordance with another broad aspect, there is provided a method of measuring an angular displacement of a rotating element in an engine, comprising: receiving a first signal generated in a first wire of a bifilar winding wrapped around at least a portion of a magnetic core, the first signal generated in response to displacement of the rotating element within a magnetic field produced by a permanent magnet; receiving a second signal generated in a second wire of the bifilar winding, the second signal generated in response to the displacement of the rotating element within the magnetic field, the first wire and the second wire being electrically insulated from one another; determining, based on the first and second signals, an angular displacement of the rotating element; and outputting an indication of the angular displacement.

In some embodiments, the method further comprises determining an angular velocity of the rotating element based on the angular displacement.

In some embodiments, the method further comprises determining a torque to which the rotating element is subjected based on the angular displacement.

In some embodiments, the method further comprises determining a mark/space ratio based on the first and second signals and determining an axial position of the rotating element based on the mark/space ratio.

In some embodiments, the method further comprises determining a propeller blade angle based on the axial position of the rotating element.

In accordance with a further broad aspect, there is provided a sensor for a rotating element in an engine. The sensor comprises: a magnetic core having a first end and a second end, the magnetic core positioned with the first end proximate to the rotating element; a permanent magnet positioned proximate the second end of the magnetic core and configured for subjecting the magnetic core and the rotating element to a magnetic field; and a bifilar winding comprising a first wire and a second wire electrically insulated from one another and wrapped around at least a portion of the magnetic core, the bifilar winding configured to generate a first signal in the first wire and a second signal in the second wire in response to rotation of the rotating element relative to the sensing system.

In accordance with a still further embodiment, there is provided a method for manufacturing a sensor for a rotating element in an engine. A magnetic core having a first end and a second end is provided. A bifilar winding, comprising a first wire and a second wire, is wrapped around at least a portion of the magnetic core, the first wire and second wire being electrically insulated from one another, the bifilar winding configured to generate a first signal in the first wire and a second signal in the second wire in response to changes in a magnetic field. The magnetic core is positioned with the first end proximate the rotating element and the second end proximate a permanent magnet configured for subjecting the magnetic core and the rotating element to the magnetic field.

Features of the systems, devices, and methods described herein may be used in various combinations, in accordance with the embodiments described herein.

### BRIEF DESCRIPTION OF THE DRAWINGS

Reference is now made to the accompanying figures in which:

FIG. 1 is a perspective view of an example magnetic sensor;

FIG. 2 is a cross-sectional view of the example magnetic sensor system of FIG. 1, taken along line 2-2′; and

FIG. 3 is a perspective view of an alternative example magnetic sensor.

It will be noted that throughout the appended drawings, like features are identified by like reference numerals.

### DETAILED DESCRIPTION

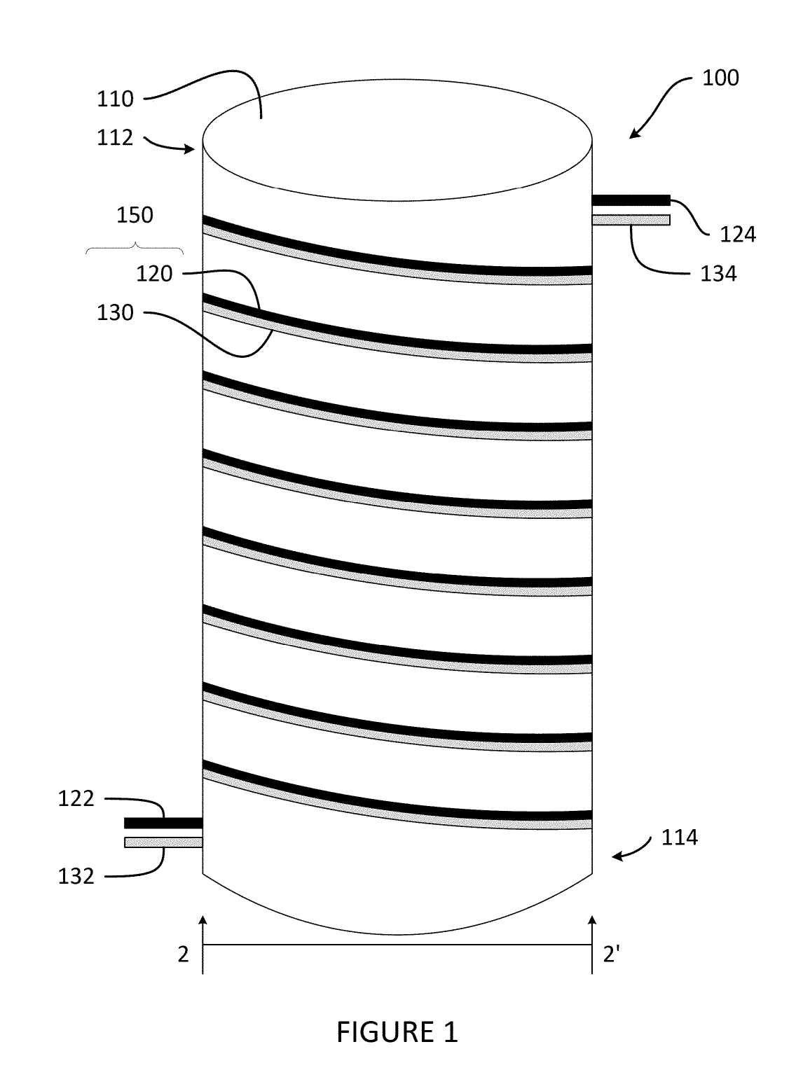

With reference to FIG. 1, there is shown a magnetic sensor 100. The magnetic sensor 100 is composed of a magnetic core 110 and a bifilar winding 150, composed of a first winding 120 and a second winding 130 (collectively “the windings”). The magnetic core 110 can be made of any suitable ferromagnetic material, for example iron, cobalt, nickel, and the like, and can be provided in any suitable shape. In some embodiments, the magnetic core 110 has a cylindrical shape, as shown in FIG. 1. The cylindrical shape of the magnetic core 110 is defined by a circular circumference, which can have any suitable radius, and has opposing first and second ends 112, 114.

In other embodiments, the magnetic core 110 has other shapes, for example a cuboid shape, such that the magnetic core is a rectangular or square prism, and the like. In embodiments in which the magnetic core 110 has a rectangular shape, the rectangular shape is defined by an outer perimeter. In some cases, the rectangular shape of the magnetic core 110 can be a square shape; in other cases, the magnetic core can be a pentagonal prism, a hexagonal prism, or any other type of prism.

The windings 120, 130 of the bifilar winding 150 are made using any suitable wire or other electrically-conductive material in which an electrical signal can be induced via a magnetic field. The windings 120, 130 are wrapped around the magnetic core 110, or around a portion thereof, forming one or more loops, as required to provide the appropriate signal amplitude, thereby circumscribing at least a portion of the magnetic core 110. The windings 120, 130 can be wrapped with or without spacing between adjacent loops, and can be wrapped with any suitable loop density. In some embodiments, the windings 120, 130 have layered loops, such that more than one layer of loops is wrapped around a same portion of the magnetic core 110.

In some embodiments, the windings 120, 130 are wound together in a common coil-form or other encapsulating material. For example, each of the windings 120, 130 is made up of a wire and an insulating shell, and both windings 120, 130 are then further wrapped in an outer insulating shell. The windings 120, 130 can be side-by-side within the common coil-form, or can be intertwined within the common coil-form. Still other designs for the bifilar winding 150 are considered.

The bifilar winding 150 is also provided with a series of leads 122, 124, 132, 134 which can be used to connect the magnetic sensor 100 to a signal processing system or control system. For example, leads 122, 124 and leads 132, 134 can be dual output signal leads (for the windings 120, 130, respectively). In some embodiments, the currents induced by changes in the magnetic field to which the magnetic core 110 is subjected flow in a common direction in both of the windings 120, 130. In other embodiments, the bifilar winding 150 is configured such that the currents in the windings 120, 130 flow in opposite directions.

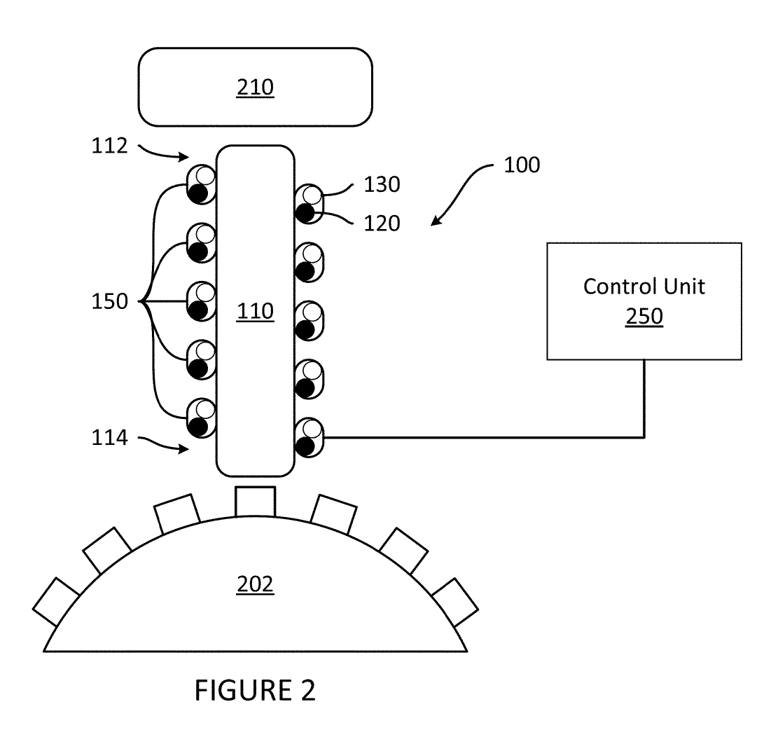

With reference to FIG. 2, in operation the magnetic sensor 100 is located in proximity to a rotating element 202 of an engine, for example the engine of an aircraft (not shown). In some embodiments, the rotating element 202 is a gear or a rotor, and is subjected to a magnetic field by way of magnet 210, which can be a permanent magnet. For clarity, only a portion of the magnetic core 110 and the windings 120, 130 are shown. For instance, in embodiments in which the magnetic core 110 is a cylindrical core, substantially the entire cylindrical core is located between the magnet 210 and the rotating element 202.

In some embodiments, the first end 112 of the magnetic core 110 is located proximate the magnet 210, and the second end 114 of the magnetic core 110, which opposes the first end 112, is located proximate the rotating element 202. In another example the first end 112 of the magnetic sensor 100 is located proximate the magnet 210, and the magnetic sensor 100 is disposed such the rotating element 202 is located at an intermediate position relative to the first end 112 and the second end 114. Still other configurations are considered.

The magnetic sensor 100 can be communicatively coupled to a control unit 250, for example via the leads 122, 124, 132, 134. For example, the control unit 250 to which the magnetic sensor 100 can be communicatively coupled can be a full-authority digital engine controls (FADEC) or other similar device, including electronic engine control (EEC), engine control unit (EUC), various actuators, and the like. When the magnetic sensor 100 and the control unit 250 are coupled, they combine to form a sensing system which can be used to measure various characteristics relating to the rotation of the rotating element 202.

The rotating element 202 is composed at least partially of ferromagnetic material, thereby causing variations in the magnetic field produced by the magnet 210. The changes in the magnetic field are then replicated in the magnetic core 110, which causes signals to be induced in the bifilar winding 150. The signals can then be interpreted by the control unit 250 to measure various characteristics relating to the rotation of the rotating element 202, including at least for determining angular displacement of the rotating element 202.

In some embodiments, the control unit 250 is configured for determining an angular or linear velocity for the rotating element 202. In other embodiments, the control unit 250 is configured for determining a torque or an acceleration to which the rotating element 202 is subjected. In still other embodiments, the control unit 250 is configured to determine a mark/space ratio of the rotating element 202. For instance, if the rotating element 202 is a gear or other toothed rotating element, the control unit 250 is configured for determining a mark/space ratio indicative of the position of the rotating element 202 based on the signals. In this case, the signals can indicate a mark when a tooth is present at a predetermined location, and a space when a gap between teeth is present at the predetermined location. In certain implementations, the mark/space ratio can be used to determine an axial position of the rotating element 202, for example when the rotating element 202 is a slanted-tooth gear.

By using bifilar windings in the magnetic sensor 100, the signals received by the control unit 250 can be more easily matched in voltage, thereby avoiding error in signal readings, while still providing dual-channel readings to meet regulatory standards for redundancy. For example, this approach can be used in conjunction with a slanted-tooth gear to measure a mark/space ratio and/or an axial position of the rotating element 202. The bifilar windings 150 of the magnetic sensor 100 can provide redundant signals of high accuracy, both on an absolute basis and relative to one another. In addition, manufacture of the magnetic sensor 100 can more easily improve the magnetic field coupling due to the geometry in the windings 120, 130, which can also lead to reduced signal error.

In some embodiments, the magnetic sensor 100 is used in conjunction with the magnet 210 to implement a beta sensor which can be used to measure various aspects of the rotation of a propeller blade of an aircraft, for example propeller pitch angle. For instance, the magnetic sensor 100 can be installed as part of an aircraft engine and located proximate an output shaft of the engine, or proximate a propeller coupled to the engine. In some other embodiments, the magnetic sensor 100 is used in conjunction with the magnet 210 to implement a phase-shift torque probe, for example by acting as a gear-tooth encoder to detect axial displacement of the rotating element 202.

A method for manufacturing the magnetic sensor 100 is also considered. The magnetic core 110 is provided, and around the magnetic core is wrapped the bifilar winding 150, which comprises windings 120 and 130. The bifilar winding is wrapped around at least a portion of the magnetic core 110. The magnetic core 110 is then positioned with the first end 112 proximate the rotating element 202 and the second end 114 proximate the magnet 210 configured for subjecting the magnetic core 110 and the rotating element 202 to a magnetic field. The control unit 250 is then communicatively coupled to the windings 120, 130, for example via leads 122, 124, 132, 134. The control unit 250 can then receive the signals produced in the windings 120, 130, and process the signals to determine various characteristics relating to the rotation of the rotating element 202, for example the speed of the rotating element 202, the torque to which the rotating element 202 is subjected, and the like.

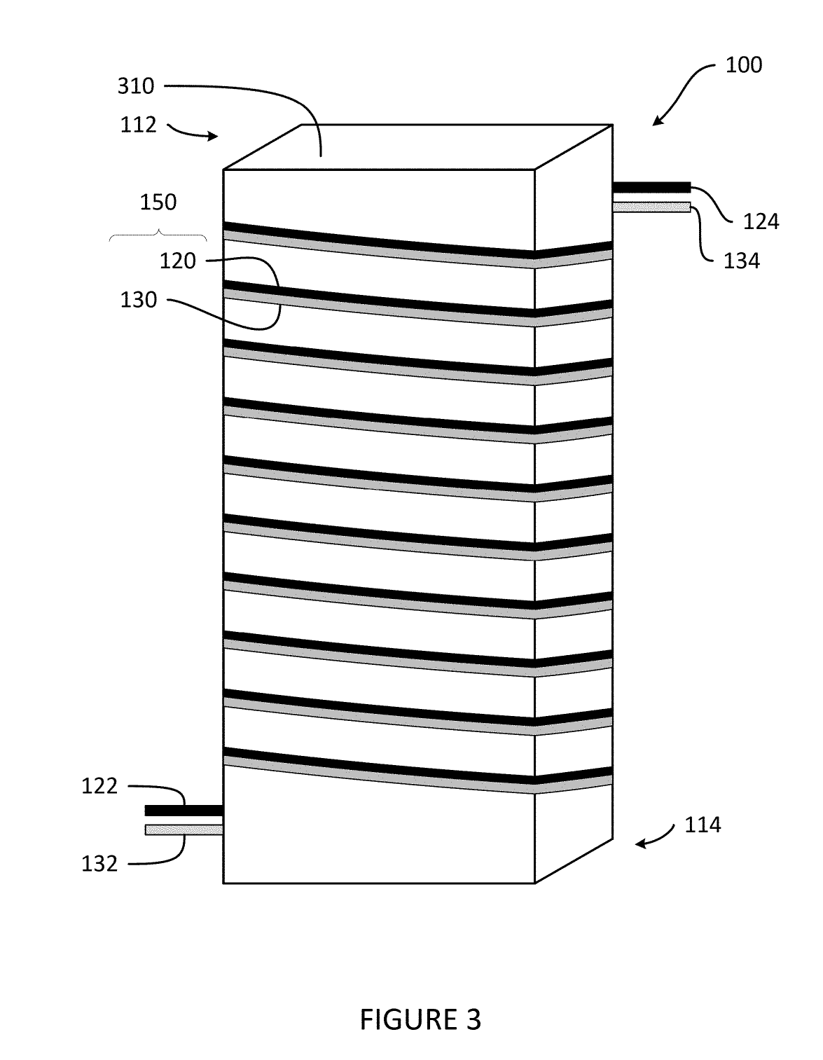

With reference to FIG. 3, an alternative embodiment of the magnetic sensor 100 with a rectangular prism magnetic core 310 is shown. The magnetic core 310 has opposing first and second ends 112, 114, and is encircled by the bifilar winding 150, with leads 122, 124, 132, and 134. It should be understood that other embodiments of magnetic cores are also considered. In some embodiments, a magnetic core can be integrated as part of a larger rotating shaft in an engine, or the like.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the sensors described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A sensing system for a rotating element in an engine, comprising:
a magnetic core having a first end and a second end, the magnetic core positioned with the first end proximate to the rotating element;
a permanent magnet positioned proximate the second end of the magnetic core and configured for subjecting the magnetic core and the rotating element to a magnetic field;
a bifilar winding comprising a first wire and a second wire electrically insulated from one another and wrapped around at least a portion of the magnetic core, the bifilar winding configured to generate a first signal in the first wire and a second signal in the second wire in response to rotation of the rotating element relative to the sensing system; and
a control unit configured for using at least the first signal and the second signal to determine an angular displacement of the rotating element.

2. The sensing system of claim 1, wherein the bifilar winding is wrapped around a portion of the magnetic core.

3. The sensing system of claim 1, wherein the bifilar winding is wrapped around substantially the entire magnetic core.

4. The sensing system of claim 1, wherein the magnetic core is cylindrical.

5. The sensing system of claim 1, wherein the magnetic core is a rectangular prism.

6. The sensing system of claim 1, wherein the rotating element is a gear.

7. The sensing system of claim 1, wherein the control unit is configured for determining an angular velocity of the rotating element based on the angular displacement.

8. The sensing system of claim 1, wherein the control unit is configured for determining a torque to which the rotating element is subjected based on the angular displacement.

9. The sensing system of claim 1, wherein the control unit uses the first signal and the second signal to determine a mark/space ratio of a slanted-tooth gear, wherein the control unit is further configured for determining an axial position of the slanted-tooth gear based on the mark/space ratio.

10. The sensing system of claim 9, wherein the control unit is further configured for determining a propeller blade angle based on the axial position of the rotating element.

11. A method of measuring an angular displacement of a rotating element in an engine, comprising:
receiving a first signal generated in a first wire of a bifilar winding wrapped around at least a portion of a magnetic core, the first signal generated in response to displacement of the rotating element within a magnetic field produced by a permanent magnet;
receiving a second signal generated in a second wire of the bifilar winding, the second signal generated in response to the displacement of the rotating element within the magnetic field, the first wire and the second wire being electrically insulated from one another;
determining, based on the first and second signals, an angular displacement of the rotating element; and
outputting an indication of the angular displacement.

12. The method of claim 11, further comprising determining an angular velocity of the rotating element based on the angular displacement.

13. The method of claim 11, further comprising determining a torque to which the rotating element is subjected based on the angular displacement.

14. The method of claim 11, further comprising determining a mark/space ratio based on the first and second signals and determining an axial position of the rotating element based on the mark/space ratio.

15. The method of claim 14, further comprising determining a propeller blade angle based on the axial position of the rotating element.

16. A sensor for a rotating element in an engine, comprising:
a magnetic core having a first end and a second end, the magnetic core positioned with the first end proximate to the rotating element;
a permanent magnet positioned proximate the second end of the magnetic core and configured for subjecting the magnetic core and the rotating element to a magnetic field; and
a bifilar winding comprising a first wire and a second wire electrically insulated from one another and wrapped around at least a portion of the magnetic core, the bifilar winding configured to generate a first signal in the first wire and a second signal in the second wire in response to rotation of the rotating element relative to the sensing system.

17. A method for manufacturing a sensor for a rotating element in an engine, comprising:
providing a magnetic core having a first end and a second end;
wrapping a bifilar winding, comprising a first wire and a second wire, around at least a portion of the magnetic core, the first wire and second wire being electrically insulated from one another, the bifilar winding configured to generate a first signal in the first wire and a second signal in the second wire in response to changes in a magnetic field; and
positioning the magnetic core with the first end proximate the rotating element and the second end proximate a permanent magnet configured for subjecting the magnetic core and the rotating element to the magnetic field.
